(19) United States
(12) Patent Application Publication
(10) Pub. No.: US 2006/0151031 A1
(43) Pub. Date: Jul. 13, 2006

(54) Directly controlled pressure control valve

(76) Inventors: Guenter Krenzer, Karlstadt (DE); Peter Lauer, Lohr (DE); Karl-Josef Meyer, Rieneck (DE)

Correspondence Address: OLIFF & BERRIDGE, PLC, P.O. BOX 19928, ALEXANDRIA, VA, 22320, US

(21) Appl. No.: 10/545,133

(22) PCT Filed: Nov. 14, 2003
(86) PCT No.: PCT/DE03/03783

§ 371 Date: Aug. 10, 2005

(30) Foreign Application Priority Data
Feb. 26, 2003 (DE) 10308487.8
May 12, 2003 (DE) 10312672.4

(51) Int. Cl. F16K 15/02

(52) U.S. Cl. 137/538

(57) ABSTRACT

What is disclosed is a directly controlled pressure control valve comprising a seat piston in a longitudinal bore of a valve housing, which is radially guided in its guidance portion through the intermediary of two circular, spaced-apart guide members in the longitudinal bore.

The invention concerns a directly controlled pressure control valve in accordance with the preamble of claim 1.

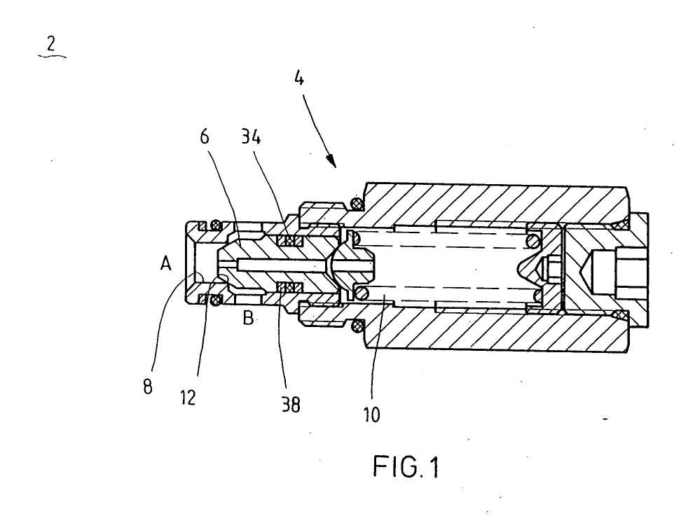

Such a pressure control valve is represented in FIG. 1. The pressure control valve depicted there originates from the applicant's data sheet RD 18 016-3.01/01.98. FIG. 1 shows a pressure control valve 2 comprising a seat piston 6 guided in a valve housing 4. The seat piston 6 is received in a longitudinal bore 8 and biased through a spring 10 against a valve seat 12 so as to block a pressure medium connection from a supply-side work port A to a drain-side work port B. The seat piston 6 is arranged in the longitudinal bore 8 with a radial play. In a peripheral groove 38 of the seat piston 6, a seal ring 34 is received which sealingly contacts the inner peripheral wall of the longitudinal bore 8.

It is a drawback in this solution that the seat piston is capable of performing rotating or pivoting movements about the seal ring in the opened position.

Owing to the resulting chattering, the seat piston is subjected to high mechanical strains, whereby the service life of such a pressure control valve is reduced.

Moreover the chattering translates into an irritating noise, such as whistling, and thus prevents low-noise operation.

It is the object of the present invention to furnish a directly controlled pressure control valve which eliminates the above mentioned drawbacks and may be manufactured at low cost.

This object is achieved through a directly controlled pressure control valve having the features in accordance with claim 1.

The pressure control valve in accordance with the invention comprises a valve housing including a supply-side work port and a drain-side work port. In the valve housing a seat piston is biased against a valve seat. In accordance with the invention, support of the seat piston in the guidance portion in the valve housing is achieved by means of at least two spaced-apart, circular guide members placed on the seat piston by their peripheral side.

It is advantageous in the solution of the invention that the seat piston is guided through at least two “bearings”—the two guide members—in a longitudinal bore of the valve housing, so that the seat piston is precluded from performing any rotating or pivoting movements about its longitudinal axis and may thus not be caused to vibrate when the pressure control valve is opened. Chattering is suppressed.

Furthermore it is an advantage of the pressure control valve of the invention that the two guide members result in damping of the seat piston in the axial direction.

The seat piston does not have an axial stop for axially limiting an opening stroke of the seat piston. The maximum opening stroke is determined by the compression of the spring. For the protection of a guide member which, in an advantageous variant, is retracted into the spring chamber and returns during the closing stroke, the longitudinal bore is radially widened in the merging range towards the spring chamber by means of a shallow chamfer, so that the retracted guide member can not be damaged during its return movement.

In a preferred embodiment, the guide members are O-seal rings having, e.g., a hardness Shore A in the area of 90.

In one embodiment, pressure medium may be returned via bores in the seat piston from the drain-side work port into the spring chamber, so that a pressure prevails in the latter that roughly corresponds to the pressure at the drain-side work port. In the biased home position at least one transverse bore towards the drain-side work port is opened through dimensional play or through a cross-section, whereas its opening cross-section may be controlled closed in dependence on the opening stroke of the seat piston, so that a pressure medium flow through the transverse bore is not possible any more but may only take place across an annular gap.

In order to stabilize the seat piston, the guide members have a maximum possible spacing from each other, with preferably the first guide member being arranged in the vicinity of the transverse bore, and the second guide member in the vicinity of the merging range of the longitudinal bore towards the spring chamber.

In order to reduce hysteresis, another embodiment provides a turned groove at the seat piston between the guide members, so that grinding of the seat piston can not occur.

In another embodiment aiming at improved response characteristics of the pressure control valve, a holding chamber having the form of a radial back-step of the seat piston with an annular end face is formed on the drain side. The holding chamber is axially defined by the valve seat and the annular end face. In the home position, pressure medium may flow off from the holding chamber along the seat piston in the direction towards the drain-side work port. A like holding chamber is described in the Applicant's older German patent application No. 102 60 662.5.

Further advantageous embodiments are subject matter of additional subclaims.

Hereinafter a detailed explanation of a preferred embodiment of the invention shall be given by referring to schematic representations, wherein:

FIG. 1 is a longitudinal sectional view of a known solution of a pressure control valve,

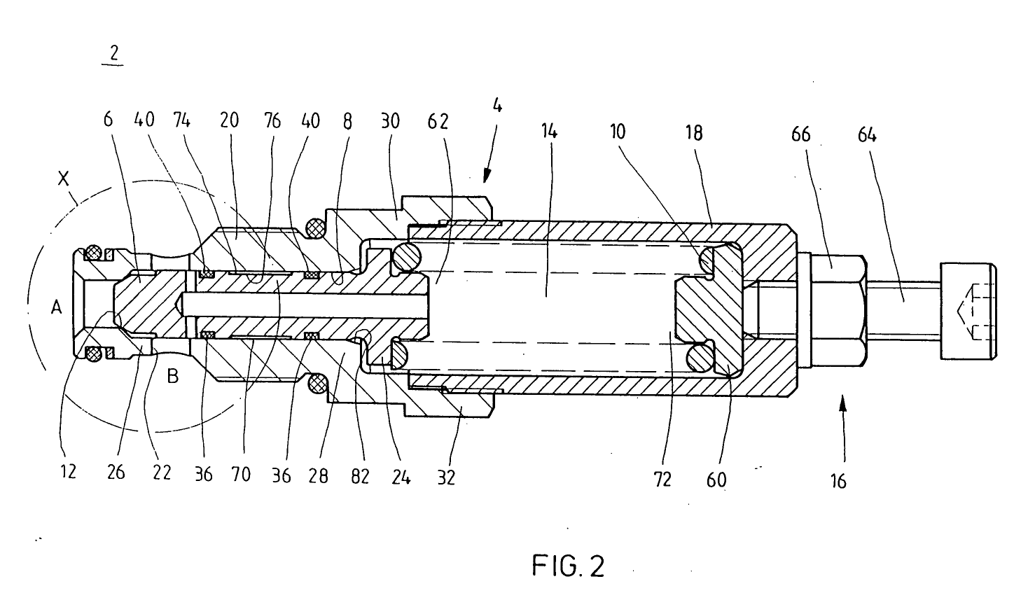

FIG. 2 is a longitudinal sectional view of a preferred embodiment of the invention,

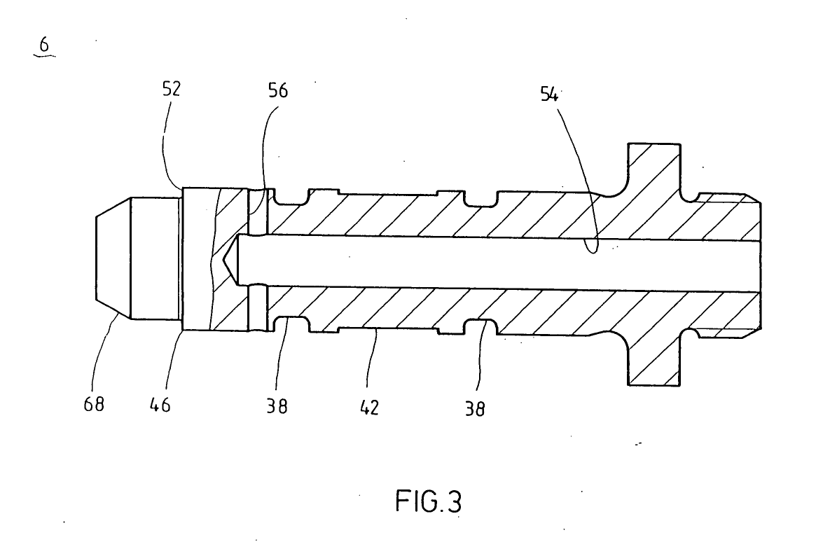

FIG. 3 is a longitudinal sectional view of the seat piston in accordance with the invention of FIG. 2, and

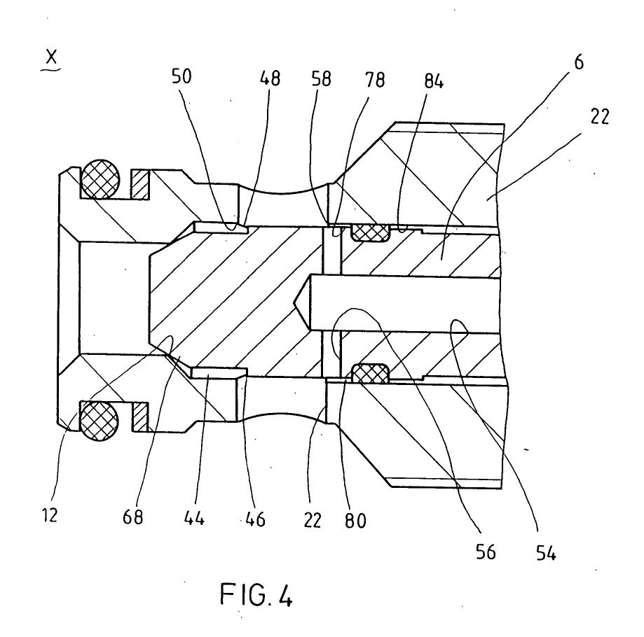

FIG. 4 is an enlarged representation of area X of FIG. 2.

FIG. 2 shows a cut-open lateral view of a preferred embodiment of a directly controlled pressure control valve 2 of the invention. The pressure control valve 2 has a multi-part valve housing 4 including a longitudinal bore 8 in which a seat piston 6 is slidingly received. The seat piston 6 is biased into its home position against a valve seat 12 through a spring 10. The spring 10 is arranged in a spring chamber 14 and adapted to be biased adjustably through the intermediary of a biasing means 16.

The valve housing 4 has a spring chamber housing 18 and a seat piston housing 20. The spring chamber housing 18 limits the spring chamber 14 for accommodating the spring 10 and is connected with the seat piston housing 20 via a screw-type engagement. In the spring chamber 14 the spring 10 is supported by an end portion 72 thereof on a biasing cup 60 of the biasing means 16. By its second end portion 62 is contacts a spring cup 24 of the seat piston 6.

The biasing means 16 is arranged in the rear area of the spring chamber housing 18. In addition to the biasing cup 60 and the spring 10, the biasing means 16 has a biasing screw 64 that extends through the spring chamber housing 18 and attacks rearwardly on the biasing cup 60. In order to set the adjusted bias, a locknut 66 is in operative engagement with the biasing screw 64 externally of the spring chamber housing 18.

In the seat piston housing 20 there are formed the longitudinal bore 8 and an axial work port A located on the supply side when viewed from the valve seat 12, as well as a drain-side radial work port B for connection work lines (not represented). The longitudinal bore 8 is open in a direction towards the axial work port A. The longitudinal bore 8 is in communication with the radial work port B through a multiplicity of regularly distributed radial bores 22 in a star-type configuration. Between the work ports A, B the valve seat 12 is formed in the seat piston housing 20 in the longitudinal bore 8.

The longitudinal bore 8 is radially widened in the direction of the spring chamber 16 across four steps 26, 28, 30, 32. The first step 26 is formed between the two work ports A, B and serves for forming the valve seat 12. The second step 28 serves in the biased home position of the seat piston 8 for receiving the spring cup 24 and the end portion 62 of the spring 10 attacking on the rear side of the spring cup 18. The third and fourth steps 30, 32 serve for receiving the spring chamber housing 18.

The seat piston 6 is radially guided in the longitudinal bore 8 in its guidance portion on the drain side beyond the radial work port B by two circular, spaced-apart guide members 36. In the described embodiment, the guide members 36 are O-seal rings that are each received in a peripheral groove 38 (FIG. 3) of the seat piston 6 and sealingly contact opposite inner peripheral portions 40 of the longitudinal bore 8.

Thanks to the use of at least two spaced-apart guide members 36 it is ensured that the seat piston 6 is guided during one stroke through the intermediary of two “bearings” in the longitudinal bore 8, so that a rotating or pivoting movement of the seat piston 6 is precluded or reduced to an acceptable degree, and it is substantially more difficult for the seat piston 6 to be made to vibrate. Radial guidance of the seat piston 6 improves with an increasing spacing between the guide members 36. Apart from this radial support function, the guide members 36 moreover assume a function of axial damping. The material of the guide members 36 is selected such that on the one hand an optimum supporting effect and damping is attained, however on the other hand the friction forces acting on the seat piston 6 through the guide members 36 are minimum, so that the response characteristics of the pressure control valve 2 are optimized. In the described embodiment, fluorocaoutchouc having a hardness Shore A in the area of 90 is selected as the material.

Between the guide members 36 the seat piston 6 is provided with a turned groove 42 (FIG. 3). As a result of this turned groove 42, which is preferably formed centrally between the guide members 36, a radial spacing of the seat piston 6 in its outer peripheral range 76 between the guide members 36 and an opposite inner peripheral range 70 of the longitudinal bore 8 is increased. The risk of tilting or friction of the seat piston 6 is hereby reduced, so that hysteresis of the pressure control valve 2 may be reduced.

The seat piston 6 does not have an axial stop for axially delimiting an opening stroke of the seat piston 6. The maximum is determined by the compression of the spring 10. For the protection against damage of a guide member 36 which plunges into the spring chamber 14 and returns into the longitudinal bore 8 during the closing stroke, the longitudinal bore 8 is radially widened in the merging range towards the spring chamber 14 through the intermediary of a shallow chamfer 82. Moreover the shallow chamfer 82 automatically results in centering of the seat piston 6 in the longitudinal bore 8 during the return movement.

On the supply side, or when viewed upstream from the radial work port B, the seat body 6 is radially stepped back so as to form a holding chamber 44 (FIG. 4) between the seat piston 6 and the seat piston housing 22 in the longitudinal bore 8. This stepped-back area continues into a front end-side conical surface 68 that contacts the valve seat 12 in the biased home position. The holding chamber 44 is axially limited by the valve seat 12, and by an annular end face 52 resulting from the radial back-step of the seat piston 6 and forming a seat piston edge 46 or spool edge. The holding chamber 44 (FIG. 4) is in the closed position already opened towards the radial bores 22 via circle segment-type cross-sections of flow 48 between the seat piston edge 46 and inner edges 50 of the radial bores 22 of the seat piston housing 20. Advantageously the seat piston edge 46 and the radial bores 22 are located at a certain spacing from the valve seat 12 or from the axial work port A, respectively, so that an axial flow of the draining pressure medium along the seat piston 6 against the annular end face 52 (FIG. 3) occurs.

When the seat piston 6 rises from the valve seat 12, the holding chamber 44 acts in conjunction with the annular end face 52 as a lifting support for the seat piston 6, whereby response characteristics of the pressure control valve largely independent from the opening stroke and thus from the spring path are realized. For a detailed description of the operation of the holding chamber 44, reference is made to the older German patent application No. 102 60 662.5 to the same applicant.

In the seat piston 6 there is formed an axial bore 54 (FIG. 3) in the manner of a blind bore, which is opened towards the spring chamber 14 and merges into at least one transverse bore 56 on the valve seat side. Thus a pressure present at the drain-side work port B may be tapped and may be present in the spring chamber 14. Preferably the transverse bore has the form of radially arranged bores. In the biased home position, the transverse bore 56 is opened towards the drain-side work port B, whereas with an increasing opening stroke its opening cross-section towards the work port B is closed by a control edge 58 of the longitudinal bore 8 (FIG. 4). The control edge 58 is formed as a circle segment in the seat piston housing 20 through the ranges of intersection of the radial bores 22 with the longitudinal bore 8. Following this closing, pressure medium can flow between the radial bores 22 and the transverse bores 56 only via a narrow annular gap 80 which extends between the outer periphery 84 of the seat piston 6 and the inner periphery 78 of the longitudinal bore 8 from the guide member 36 of the seat piston 6 facing the drain-side work port B to the control edge 58 of the longitudinal bore 8, whereby damping of the seat piston 6 is enhanced.

As was already explained above, the guide members 36 are given a maximum possible spacing for an improved stabilization of the seat piston 6. Preferably a guide member 36 is arranged in the vicinity of the transverse bore 56, and the other guide member 36—in the home position—in the vicinity of the merging range of the longitudinal bore 8 towards the spring chamber 14 (FIG. 2).

What is disclosed is a directly controlled pressure control valve comprising a seat piston in a longitudinal bore of a valve housing, which is radially guided in its guidance portion through the intermediary of two circular, spaced-apart guide members in the longitudinal bore.

### LIST OF REFERENCE SYMBOLS

2 pressure control valve
4 valve housing
6 seat piston
8 longitudinal bore
10 spring
12 valve seat
14 spring chamber
16 biasing means
18 spring chamber housing
20 seat piston housing
22 radial bore
24 spring cup
26 first step
28 second step
30 third step
32 fourth step
34 seal ring
36 guide members
38 peripheral groove
40 inner peripheral portion
42 turned groove
44 holding chamber
46 seat piston edge
48 cross-section of flow
50 inner edge
52 annular end face
54 axial bore
56 transverse bore
58 control edge
60 biasing cup
62 end portion
64 biasing screw
66 locknut
68 conical surface
70 inner peripheral range
72 end portion
74 annular chamber
76 outer peripheral range
78 inner periphery
80 annular gap
82 chamfer
84 outer periphery

1. A directly controlled pressure control valve comprising a seat piston biased against a valve seat in a valve housing for opening and closing a pressure medium connection between a supply-side port A and a drain-side work port A, B, characterized in that the seat piston includes in the guidance portion at least two spaced-apart, circular guide members placed on the seat piston by their peripheral side, whereby the seat piston is radially supported in the valve housing.

2. The directly controlled pressure control valve in accordance with claim 1, characterized in that the guide members are O-seal rings.

3. The directly controlled pressure control valve in accordance with claim 1, characterized in that the guide members possess a hardness Shore A in the area of 90.

4. The directly controlled pressure control valve in accordance with claim 1, characterized in that a turned groove is formed on the seat piston between the guide members.

5. The directly controlled pressure control valve in accordance with claim 1, characterized in that bores for applying a pressure in the spring chamber are formed in the seat piston, wherein in the closed condition of the valve at least one transverse bore is opened towards the drain-side work port B, and its opening cross-section towards the work port B is adapted to be closed in dependence on an opening stroke of the seat piston.

6. The directly controlled pressure control valve in accordance with claim 1, characterized in that the longitudinal bore is radially widened in the merging range towards the spring chamber through the intermediary of a chamfer.

7. The directly controlled pressure control valve in accordance with claim 1, characterized in that the guide members are widely spaced apart from each other, with the first guide member being positioned in the vicinity of the transverse bore, and the second guide member—in the home position—near the merging range of the longitudinal bore towards the spring chamber.

8. The directly controlled pressure control valve in accordance with claim 1, characterized in that on the drain side a holding chamber having an annular end face is formed so as to constitute a lifting support.

9. The directly controlled pressure control valve in accordance with claim 8, characterized in that the holding chamber is formed by a radial back-step of the seat piston, with the holding chamber being axially delimited by the valve seat and an annular end face of the seat piston.

10. The directly controlled pressure control valve in accordance with claim 8, characterized in that an axial spacing is present between the valve seat and the drain-side work port B and of such a magnitude that an axial flow of the draining pressure medium occurs along the seat piston.
